(19) United States
(12) Patent Application Publication
(10) Pub. No.: US 2023/0401934 A1
(43) Pub. Date: Dec. 14, 2023

(54) Method, Apparatus, And Program Product For Triggering And Controlling Gaming Machine Operation In Reel-Type Games With An Expanding Array

(71) Applicant: Everi Games, Inc., Austin, TX (US)

(72) Inventor: Scott Slomiany, Rolling Meadows, IL (US)

(73) Assignee: Everi Games, Inc., Austin, TX (US)

(21) Appl. No.: 17/836,184

(22) Filed: Jun. 9, 2022

(51) Int. Cl. G07F 17/34; G07F 17/32

(52) U.S. Cl. CPC G07F 17/34; G07F 17/3213; G07F 17/3227

(57) ABSTRACT

A method includes controlling a display system of a gaming machine to display a symbol array including an active array area and an expansion array area. Designated symbols are visible in the expansion array area. Responsive to designated conditions, the active array area is expanded to include portions of the expansion array area.

### TECHNICAL FIELD OF THE INVENTION

The invention relates to gaming systems and methods which provide reel-type games. More particularly, the invention relates to gaming systems and methods which provide improved mechanisms for expanding an array of reels in a reel-type game.

### BACKGROUND OF THE INVENTION

Mechanical and video reel-type wagering games display results for a given play in the game using an array of game symbol locations. In the course of a play in a reel-type wagering game (which may be referred to generally as a “slot game”), the various game symbols appearing at the different game symbol locations (or at least some of the different game symbol locations) are randomized or selected according a random result. The randomization or apparent randomization is performed by spinning a reel which carries on its periphery the various game symbols for the game, or, in the case of video reel-type games, by conducting a reel spin simulation for one or more simulated reels shown on a video display. A reel-type game may include physical or simulated multiple-symbol reels which each provide multiple game symbol locations in the array, or may include physical or simulated single-symbol reels which each show only a single game symbol location of the array.

Winning results may be defined for a given combination of game symbols appearing in a predefined winning game symbol location pattern commonly referred to as a “payline” defined through the array of game symbol locations. Winning results may also be defined in terms of the number of a given game symbol or different game symbols appearing in the array after randomization, commonly referred to as a “scatter pay.” The combinations of game symbols which represent a winning result along a payline or as a scatter pay are defined in a pay table which relates each such combination of game symbols to a respective prize, or multiple prizes with each prize corresponding to a bet level in effect for the play in the game. Any prizes as defined by the pay table are awarded in some fashion at the completion of a given play such as by incrementing a credit meter at the gaming machine.

Reel-type gaming machines may offer special features in addition to a primary or base game conducted at a gaming machine. Such special features are seen as a way to vary the player's gaming experience at a given gaming machine and may involve spins of the same or different physical or simulated reels defining the original game symbol location array. In view of the popularity of special features for reel-type gaming machines, there is a continuing need both for new implementations of special features and new implementations for triggering such features in a game.

### SUMMARY OF THE INVENTION

Aspects of the present invention include methods, apparatus, and program products for providing array expansion features in reel-type gaming machine. Additional aspects of the present invention encompass methods, apparatus, and program products for controlling the operation of reel-type gaming machines.

In accordance with this first aspect of the invention, a method is provided for controlling a reel-type gaming machine. The method includes controlling a display system of the gaming machine to display a game symbol array for a play at the gaming machine including an active array area in which symbols are shown and evaluated, and an expansion array area in which symbols are not shown or are shown in an inactive state. During the play at the gaming machine, the method populates at least some game symbol locations in the active array area and at least some game symbols in the expansion array area with a respective game symbol selected from a first game symbol set which includes a first expansion symbol. Responsive to an expansion condition in which a selected expansion symbol appears in the expansion area adjacent to a boundary between the active array area and the expansion array area, the method controls the display system of the gaming machine to enlarge the active array area by moving the boundary only sufficiently to include the selected expansion symbol Responsive to moving the boundary, the method includes showing and evaluating symbols in a new active array area created by moving the boundary. After moving the boundary, the method includes controlling the gaming machine to award any prize defined for a winning game symbol group contained in the enlarged active array area.

A gaming machine according to a second aspect of the present invention includes a display system, a player input system, and least one processor. At least one memory device of the gaming machine stores instructions which are executable by the at least one processor to produce the active array area and the expansion array area, display a game play through the gaming machine, and award prizes in accordance with the above-described method.

Because methods and gaming machines according to the present invention may be implemented with processing devices operating under the control of program code, another aspect of the present invention includes a program product comprising one or more non-transitory computer readable data storage devices storing program code. The program code is executable by one or more processors such as a gaming machine processor arrangement to perform the operations described above in connection with methods according to the invention.

These and other advantages and features of the invention will be apparent from the following description of representative embodiments, considered along with the accompanying drawings.

### BRIEF DESCRIPTION OF THE DRAWINGS

FIG. 1 is a perspective view of a gaming machine that may be used for a target interactive game in accordance with implementations of the present invention.

FIG. 2 is a block diagram showing the various components that may be included in the gaming machine shown in FIG. 1.

FIG. 3 is a block diagram of a gaming system including gaming machines such as that shown in FIG. 1.

FIG. 4 is a process flow diagram showing a process for operating a game according to some aspects of the present invention.

FIG. 5 illustrates in diagram form a game screen of a reel-type game in accordance with aspects of the present invention

FIGS. 6-11 are a sequence of game screen diagrams representing a game over several points in time according to various aspects of the present invention.

### DESCRIPTION OF REPRESENTATIVE EMBODIMENTS

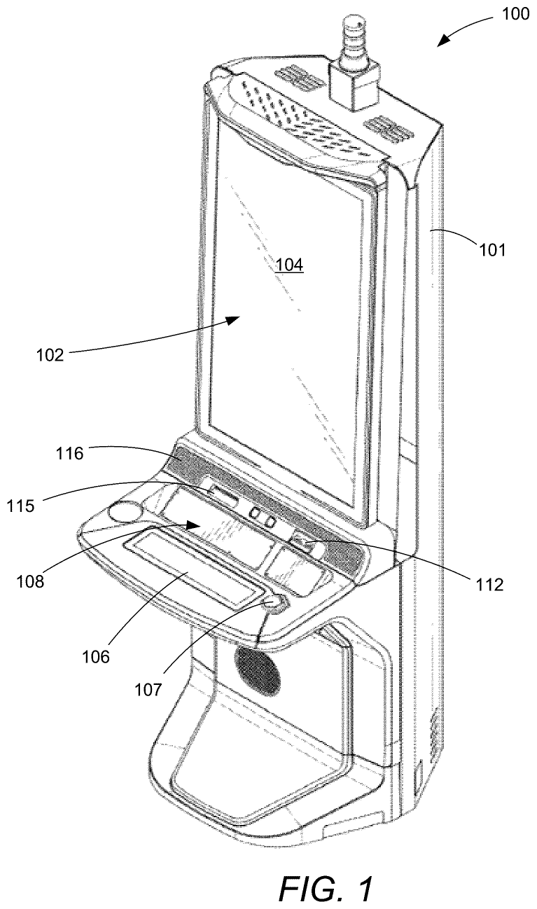

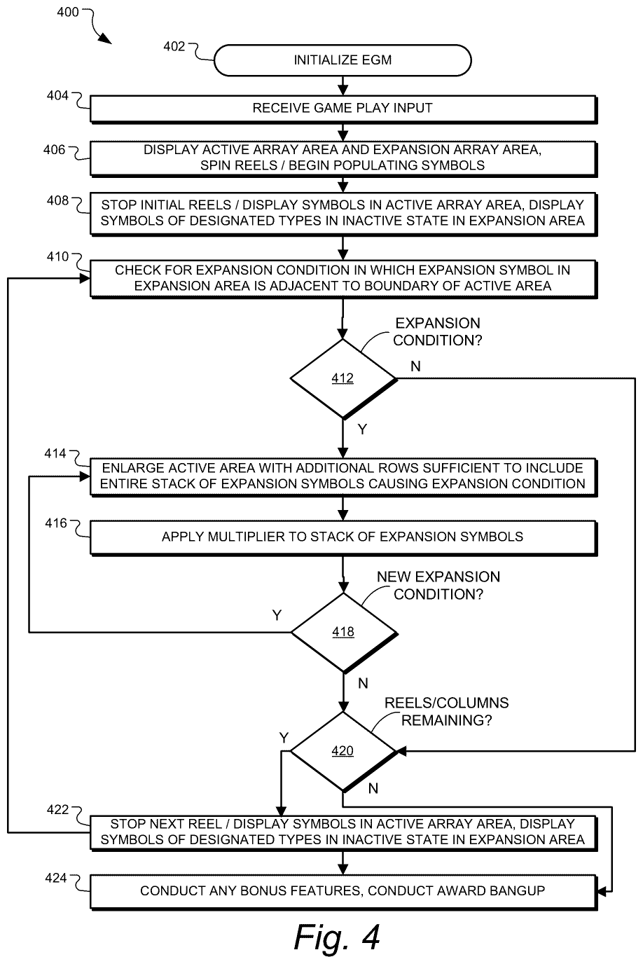

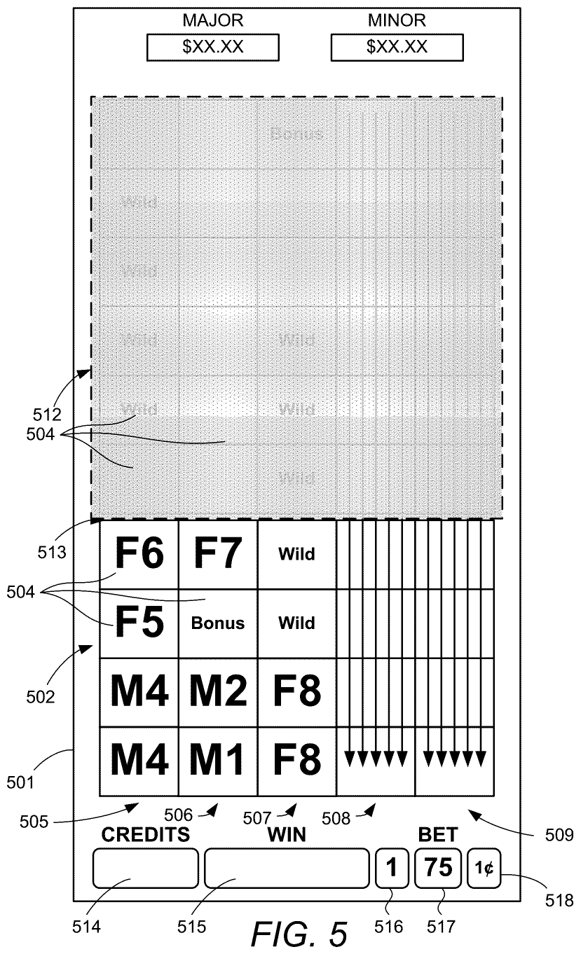

FIGS. 1-3 will be used to describe gaming machines and gaming networks in which aspects of the present invention may be implemented. FIG. 4 will be used to describe example methods of controlling a gaming machine to conduct a game according to various implementations of the present invention. FIGS. 5-11 will be referenced below to describe operation of gaming machines according to various implementations.

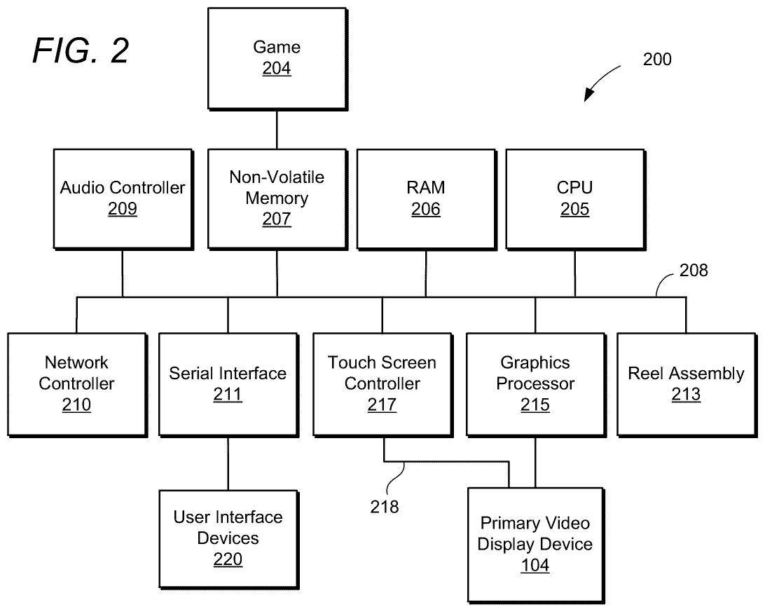

Referring to FIG. 1, gaming machine 100 includes a cabinet 101 having a front side generally shown at reference numeral 102. A primary video display device 104 is mounted in a central portion of the front side 102, and a touch-screen button panel 106 is positioned below the primary video display device. Gaming machine 100 may include additional smaller auxiliary display devices (not shown) in the area shown generally at 108. It should also be noted that each display device referenced herein may include any suitable display device including a cathode ray tube, liquid crystal display, plasma display, LED display, or any other type of display device currently known or that may be developed in the future. One or more of these video display devices, and especially primary video display device 104, may be used to display graphics associated with a reel-type game in accordance with aspects of the present invention. As will be described further below in connection with FIG. 2 and elsewhere, it is also possible for gaming machines within the scope of the present invention to include mechanical elements such as mechanical reels. Generally, the display device or display devices of the gaming machine, through which a reel-type game may be presented may be described in this disclosure and the accompanying claims as a “display system” regardless of whether the display arrangement includes video displays showing reel simulations or physical reels, or combinations of the two.

The gaming machine 100 illustrated for purposes of example in FIG. 1 also includes a mechanical control button 107 mounted adjacent to touch-screen button panel 106. This control button 107 may allow a player to make a play input to start a play in a wagering game conducted through gaming machine 100, while virtual buttons included (but not shown in this view) on button panel 106 or other physical buttons or controls (not shown) may allow a player to select a bet level for a game implemented at the gaming machine and select a type of game or game feature. Touch-screen button panel 106 may also be used in implementations of reel-type games encompassing aspects of the invention to allow the player to control a cursor that may be displayed on another display device. Other forms of gaming machines through which the invention may be implemented may include switches, joysticks, or other mechanical input devices, in addition to the virtual buttons and other controls implemented on touch-screen button panel 106. For example, primary video display device 104 in gaming machine 100 provides a convenient display device for implementing touch screen controls in addition to or in lieu of controls included on touch-screen button panel 106 or mechanical controls. The player interface devices which receive player inputs in the course of a game played through the gaming machine, such as controls to select a wager amount for a given play, controls to enter a play input to actually start a given play in the wagering game, or controls to allow a player to make other player inputs in a game according to the present invention, may be referred to generally as a “player input system.”

It will be appreciated that gaming machines may also include a number of other player interface devices in addition to devices that are considered player controls for use in entering inputs in the course of a particular game. Gaming machine 100 also includes a currency/voucher acceptor having an input ramp 112, a voucher/receipt printer having a voucher/receipt output 115, and a player card reader (not shown in the view of FIG. 1). Numerous other types of player interface devices may be included in gaming machines that may be used to implement embodiments of the present invention.

Gaming machine 100 may also include a sound system to provide an audio output to enhance the user's playing experience. For example, illustrated gaming machine 100 includes speakers behind grille 116 which may be driven by a suitable audio amplifier (not shown) to provide a desired audio output at the gaming machine.

FIG. 2 shows a logical and hardware block diagram 200 of gaming machine 100 which includes a processor (CPU) 205 along with random access memory (RAM) 206 and nonvolatile memory or storage device 207. All of these devices are connected on a system bus 208 with an audio controller device 209, a network controller 210, and a serial interface 211. A graphics processor 215 is also connected on bus 208 and is connected to drive primary video display device 104 (the display device 104 being mounted on cabinet 101 as shown in FIG. 1). As shown in FIG. 2, gaming machine 100 also includes a touch screen controller 217 connected to system bus 208. Touch screen controller 217 is also connected via signal path 218 to receive signals from a touch screen element associated with primary video display device 104 or touch-screen button panel 106 or both. It will be appreciated that the touch screen element itself typically comprises a thin film that is secured over the display surface of the respective display device such as the display device of touch-screen button panel 106 in FIG. 1. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer, although they may be specially designed and configured for use in a wagering game environment. These elements may be mounted on (or connected to) a standard personal computer motherboard and housed in a standard personal computer housing which itself may be mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller for example. It will also be appreciated that some of the devices shown in FIG. 2 as being connected directly on system bus 208 may in fact communicate with the other system components through a suitable expansion bus. Audio controller 209, for example, may be connected to the system via a PCI or PCIe bus. System bus 208 is shown in FIG. 2 merely to indicate that the various components are connected in some fashion for communication with CPU 205 and is not intended to limit the invention to any particular bus architecture. Numerous other variations in the gaming machine internal structure and system may be used without departing from the principles of the present invention. For example, a gaming machine in some embodiments of the present invention may rely on one or more data processors which are located remotely from the gaming machine itself. Embodiments of the present invention may include no processor such as CPU 205 or graphics processor such as 215 at the gaming machine, and may instead rely on one or more remote processors. Thus unless specifically stated otherwise, the designation “gaming machine” is used in this disclosure and the accompanying claims to designate a system of devices which operate together to provide the indicated functions. A “gaming machine” may include a gaming machine such as gaming machine 100 shown in FIGS. 1 and 2, which is itself a system of various components, and may also include one or more components remote from a gaming machine cabinet (that is, cabinet 101 in FIG. 1). Thus the designation “gaming machine” encompasses both a stand-alone gaming machine and a gaming machine (that is, the part housed in a cabinet such as cabinet 101 in FIG. 1) along with one or more remote components for providing various functions (such as identifying prizes for a given play and controlling reel spin simulations, and performing other operations described below in the examples of FIGS. 4A and 4B.

It will also be appreciated that graphics processors are also commonly a part of modern computer systems. Although separate graphics processor 215 is shown for controlling primary video display device 104, CPU 205 or a graphics processor packaged with or included with CPU 205 may control all of the display devices directly without any separately packaged graphics processor. The invention is not limited to any particular arrangement of processing devices for controlling the video display devices included with gaming machine 100. Also, a gaming machine implementing the present invention is not limited to any particular number of video display devices or other types of display devices. While the large display device 104 is particularly suited for showing additional groups of game symbol locations in accordance with some implementations of reel-type games in accordance with aspects of the present invention, the display area may be arranged differently than the portrait orientation shown or divided across multiple discrete display devices within the scope of the present invention.

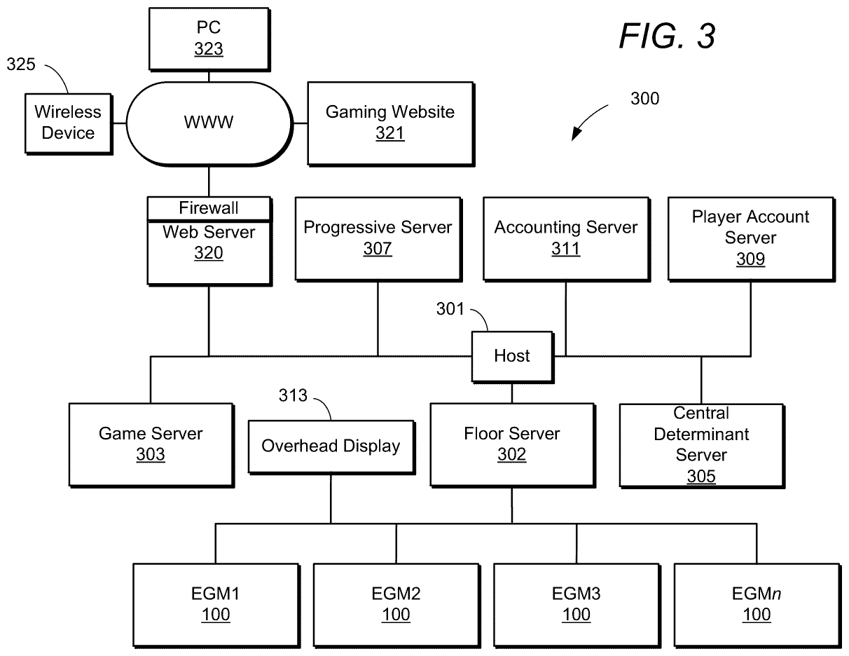

In the illustrated gaming machine 100, CPU 205 executes software, that is, program code, which ultimately controls the entire gaming machine including the receipt of player inputs and the presentation of the graphics or information displayed according to the invention through the display devices 104 and 106 associated with the gaming machine. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for game software (program code) prior to loading into random access memory 206 for execution, or for programs not in use or for other data generated or used in the course of gaming machine operation. Network controller 210 provides an interface to other components of a gaming system in which gaming machine 100 may be included. An example network will be described below in connection with FIG. 3.

It should be noted that the invention is not limited to gaming machines employing the personal computer-type arrangement of processing devices and interfaces shown in example gaming machine 100. Other gaming machines through which the invention may be implemented may include one or more special purpose processing devices to perform the various processing steps for implementing the invention. Unlike general purpose processing devices such as CPU 205, which may comprise an Intel® or AMD® processor for example, these special purpose processing devices may not employ operational program code to direct the various processing steps.

The example gaming machine 100 is shown in FIG. 2 as including user interface devices 220 (part of a player input system) connected to serial interface 211. These user interface devices may include various player input devices such as mechanical buttons, virtual buttons shown on touch-screen button panel 106 in FIG. 1, and/or levers, and other devices. It will be appreciated that the interface between CPU 205 and other player input devices such as player card readers, voucher readers or printers, and other devices may be in the form of serial communications. Thus serial interface 211 may be used for those additional devices as well, or the gaming machine may include one or more additional serial interface controllers. However, the interface between peripheral devices in the gaming machine, such as player input devices, is not limited to any particular type or standard for purposes of the present invention.

Reel Assembly 213 is shown in the diagrammatic representation of FIG. 2 to illustrate that a gaming machine which may present reel-type games in accordance with aspects of the present invention may also include mechanical reels. For example, a number of sets of mechanical reels may replace the primary display device 104, or at least part of that display device. Alternatively, mechanical reels may be included in the gaming machine behind a light-transmissive video display panel. Mechanical reels may also include one or more video display devices in place of a static reel symbol strip and thus be capable of conducting single-symbol reel spin simulations for one or more game symbol locations. In any case, the mechanical reels represent a display device for displaying various game symbols in the course of a game play. Although the invention is not limited to any particular mechanical reel arrangement or control system, mechanical reels may be controlled conveniently through serial communications which provide instructions for a respective stepper motor for each reel. Thus some embodiments of the present invention which employ mechanical reels may use a serial interface device such as serial interface 211 to control communications with the reel assembly, and may not include a direct bus interconnection as indicated by FIG. 2. Details of a mechanical reel arrangement and various accent lighting arrangements which may be associated with mechanical reels are not shown in the present FIG.s so as to avoid obscuring the present invention in unnecessary detail.

Referring now to FIG. 3, a networked gaming system 300 associated with one or more gaming facilities may include one or more networked gaming machines 100 (shown in FIG. 3 as EGM1-EGMn) connected in the network by suitable network cable or wirelessly. Networked gaming machines 100 and one or more overhead displays 313 may be operatively connected so that the overhead display or displays may mirror or replay the content of one or more displays of gaming machines 100. For example, the primary display content for a given gaming machine 100 (including a game play according to the present invention) may be transmitted through network controller 210 to a controller associated with the overhead display(s) 313. In the event gaming machines 100 have cameras installed, the respective player's video images may be displayed on overhead display 313 along with the content of the player's gaming machine display.

The example gaming network 300 shown in FIG. 3 includes a host server 301 and floor server 302, which together may function as an intermediary between floor devices such as gaming machines 100 and back office devices such as the various servers described below. Game server 303 may provide server-based games and/or game services to network connected gaming devices such as gaming machines 100. Central determinant server 305 may be included in the network to identify or select lottery, bingo, or other centrally determined game outcomes and provide the outcome information to networked gaming machines 100 which present the games to players.

Tournament server 306 may be included in the system for controlling or coordinating tournament functions. These functions may include maintaining tournament player scores and ranking in reel time during the course of tournament play, and communicating this information to the various gaming machines 100 participating in the tournament. Tournament server 306 may also function to enroll players in tournaments, schedule tournaments, and maintain the time remaining in the various tournaments.

Progressive server 307 may maintain progressive pools for progressive games which may be available through the various gaming machines 100 (such as some prizes defined for the game described further below). In some implementations, progressive server 307 may simply receive communications indicating contribution amounts which have been determined by processes executing at the various gaming machines 100 or elsewhere in the gaming network. Alternatively, progressive server 307 may perform processes to determine the contribution amounts for incrementing the various progressive pools which may be maintained. Progressive server 307 may also periodically communicate current pool values back to the various gaming machines 100, and may participate in communicating awarded progressive prize amounts to the gaming machines and making adjustments to the progressive prize pools accordingly. In some implementations, progressive server 307 may also determine or participate in determining when a progressive prize triggering event occurs.

Accounting server 311 may receive gaming data from each of the networked gaming devices, perform audit functions, and provide data for analysis programs. Player account server 309 may maintain player account records, and store persistent player data such as accumulated player points and/or player preferences (for example, game personalizing selections or options).

Example gaming network 300 also includes a gaming website 321 which may be hosted through web server 320 and may be accessible by players via the Internet. One or more games may be displayed as described herein and played by a player through a personal computer 323 or handheld wireless device 325 (for example, a Blackberry® cell phone, Apple® iPhone®, personal digital assistant (PDA), iPad®, etc.). To enter website 321, a player may log in with a user name that may, for example, be associated with the player's account information stored on player account server 309. Once logged in to website 321 the player may play various games on the website, including games according to the invention. Also website 321 may allow the player to make various personalizing selections and save the information so it is available for use during the player's next gaming session at a casino establishment having the gaming machines 100.

It will be appreciated that gaming network 300 illustrated in FIG. 3 is provided merely as an example of a gaming network which may facilitate target interactive games according to aspects of the present invention, and is not intended to be limiting in any way. Reel-type games according to aspects of the present invention are not limited to use with gaming networks such as network 300.

FIG. 4 show a flowchart 400 of an example method of conducting game plays in a reel-type gaming machine in accordance with aspects of the present invention. The depicted process is suitable for implementation under control of a processor of a gaming machine such as processor 205 executing program code stored on a non-volatile memory such as memory device 207 (FIG. 2). The illustrated method includes initializing the EGM (such as gaming machine/EGM 100 shown in FIGS. 1 and 3) at block 402 and then receiving a game play input as shown at block 404. Initializing the gaming machine as indicated at block 402 may include, for example, receiving an input of credits for play from a player. Credits may be applied to the gaming machine through a voucher system, player account system, or any other arrangement. In any event, initializing the gaming machine places it in condition to receive game play inputs as indicated at block 404. These game play inputs may be received in any suitable fashion, such as, for example, through a player actuated control such as a “Play” button or lever. Each game play input may be associated with a wager which is selected or entered by the player through a suitable control included in the player input system.

In response to the game play input, at block 406, the process includes displaying an active array area and an expansion array area, and populating game symbol locations at block 406. An example of an active array area and expansion array area are discussed below with respect FIG. 5. In some embodiments, the active array area may be populated all at once, by spinning and stopping all reels of the game simultaneously. However, in preferred embodiments, the process includes conducting a spin for physical reels or a spin simulation for video simulated reels, and then causing the reels or simulated reels to come to a stop in a sequence.

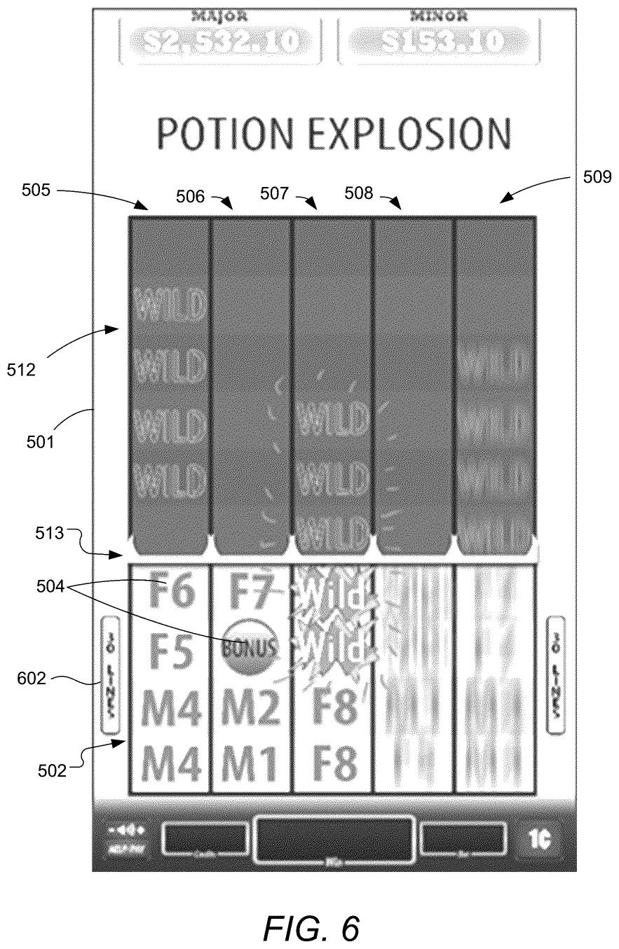

Such a sequence is begun at block 408, where the process stops an initial set of reels, with game symbols on the reels thereby aligning with the various game symbol locations of the active array area and expansion array area. In the active array area, all symbols spun up on the reels are visible. In the expansion array area, only designated types of symbols that spin up on the reels or otherwise appear in the array are visible, and are shown in an inactive state. In this context, inactive means that the symbols are at least temporarily not available to be evaluated to form winning patterns or winning groups of symbols according to the game paytable. The inactive symbols in the expansion array area may be visually altered from their versions appearing in the active array area to indicate to the player that they are inactive (see the stack of “Wild” symbols in the expansion array area 512 on reel 505 of FIG. 6, for example, which appear differently from the “Wild” symbols in active array area 502). The game symbols which are populated to the active array area and expansion array area are selected from a first game symbol group which includes a first expansion symbol appearing in stacks of at least two expansion symbols. While in this embodiment, the first expansion symbol appears in stacks, in other embodiments, single expansion signals may also appear and trigger an expansion condition as described below. Other groups of symbols such as bonus symbols may also be shown in the expansion array area. In some embodiments, bonus symbols are inactive unless the active array area is expanded to include them, as further described below. In some bonus features, bonus symbols in the expansion array area may activated or processed by the game to provide bonus features.

At block 410, the process checks for the presence of responsive of an expansion condition in which a selected stack of expansion symbols includes a symbol in the expansion array area adjacent to a boundary between the active array area and the expansion array area. An example of such a condition in FIG. 5 in reel 507, where an expansion symbol (labelled “Wild”) is present above the boundary 513 between active array area 502 and expansion array area 512, as further described below. If an expansion condition exists, the process at block 412 goes to block 414. If not, the process at block 412 goes to block 418. While this particular expansion condition is used in the embodiment of FIG. 5, other embodiments may employ other expansion conditions. For example, a stack of expansion symbols may be required to span the boundary 513 to qualify as an expansion condition.

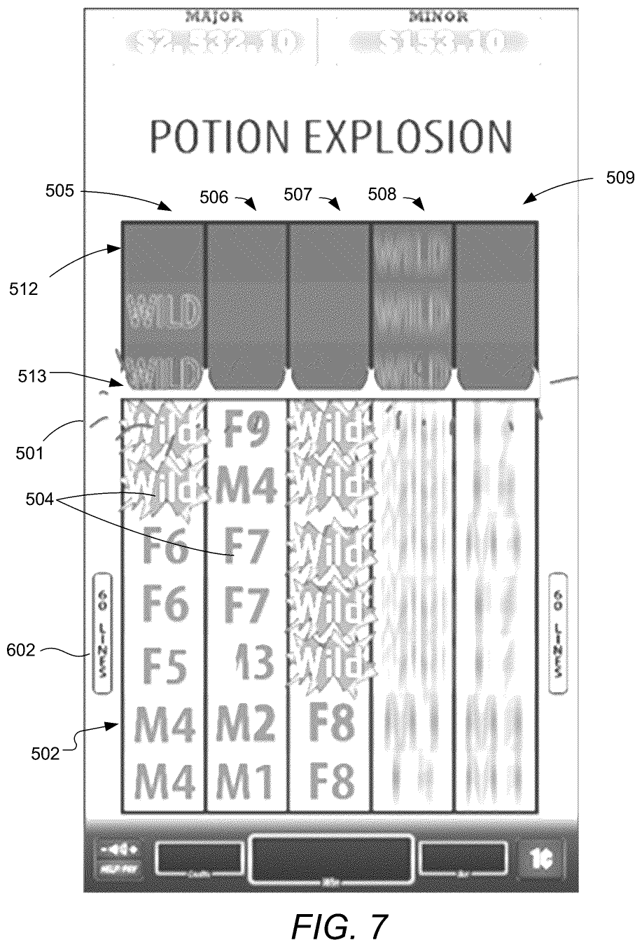

Responsive to an expansion condition, the process at block 414 includes controlling the display system of the gaming machine to enlarge the active array area by moving the boundary only sufficiently to include the selected stack of expansion symbols. An example of such an enlargement is shown in the sequence of FIG. 6 and FIG. 7, in which boundary 513 is moved sufficient for active area. Block 414 may also include increasing a number of paylines used to form winning game symbol groups when enlarging the active array area. Such an increase is seen in the sequence of FIG. 6 and FIG. 7 in a payline indicator 602, which shows the original active array area including 30 paylines in FIG. 6, and then including 60 paylines after it is expanded as shown in FIG. 7.

Responsive to moving the boundary at block 414, the process includes showing and evaluating symbols in a new active array area created by moving the boundary. The newly-shown symbols are shown immediately, as shown in FIG. 7 by the symbols that are previously unseen occupying symbol locations 504 in the three new rows included in active array area 502. The evaluation typically occurs after all the reels or columns are populated (after the decision at block 420 goes to block 424). Therefore the expansion symbols, responsive to appearing in the active array area, are evaluated as wild symbols, and responsive to appearing in the expansion array area, are evaluated only for causing an expansion event, and then evaluated as wild symbols responsive to appearing in the enlarged active array area.

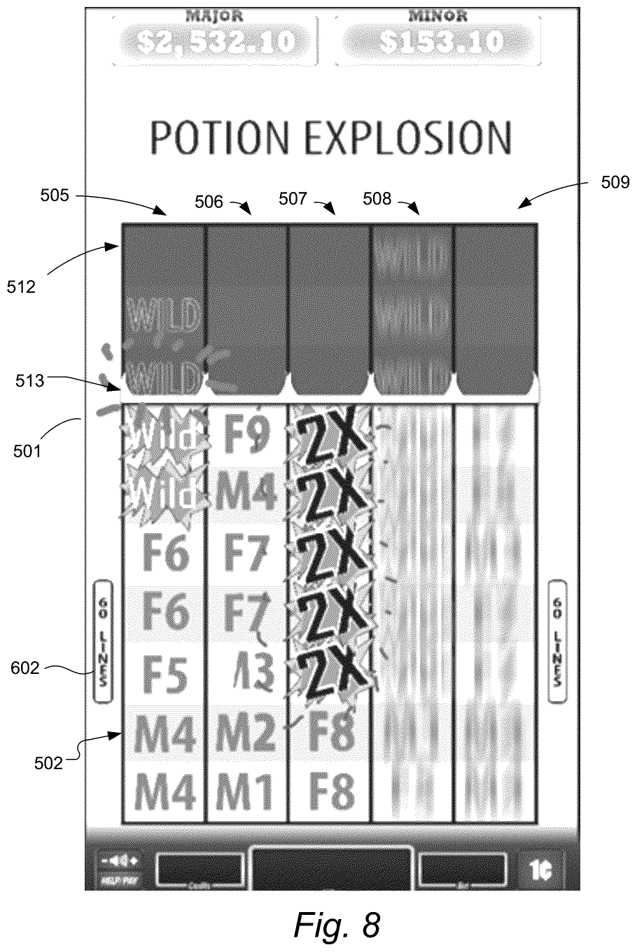

At block 416, in this embodiment, the process includes applying a first multiplier to all winning game symbol groups formed using the selected stack of expansion symbols. Such a multiplier is shown being applied to the stack of expansion symbols causing the expansion in FIG. 8, as indicated by the “2×” graphic displayed on the symbols, indicating that a 2× multiplier is applied to winning symbol groups formed using those symbols.

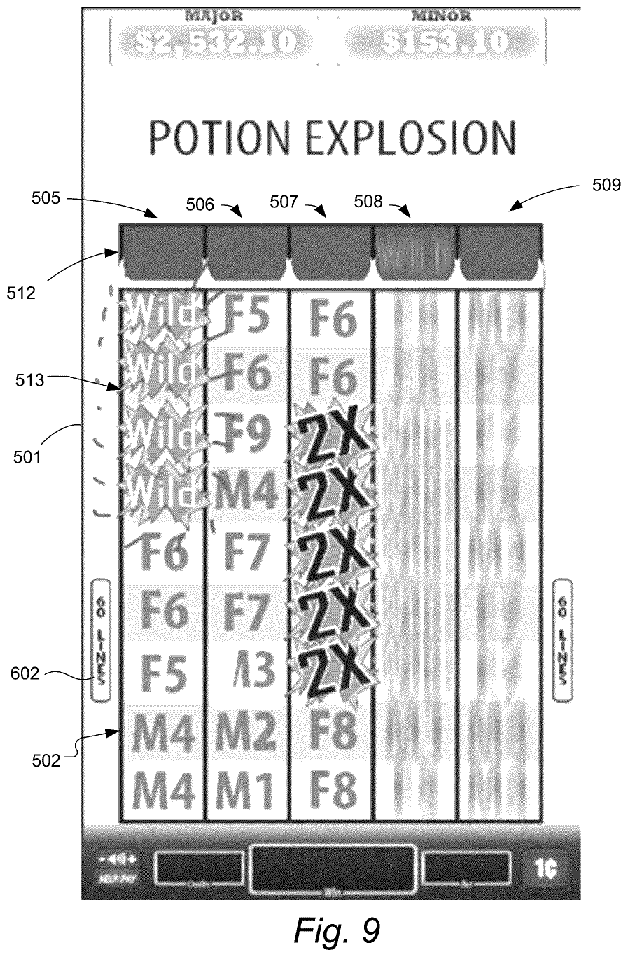

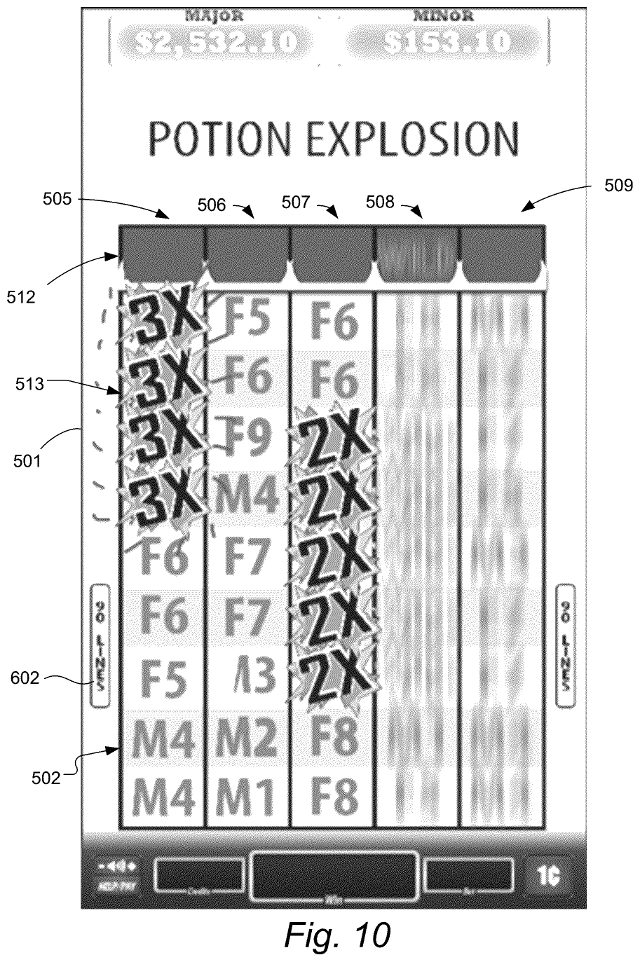

Next, at block 418, the process evaluates the modified conditions of the game for a new expansion condition. The qualification for an expansion condition is the same as used in block 410. If a new expansion condition exists, the process returns to block 414 to enlarge the active array area responsive to the new expansion condition. If not, the process goes to block 420. As seen in the example scenario of FIG. 8 and FIG. 9, a new expansion condition may be formed by the movement of boundary 513. For example, on reel 505 of FIG. 8, a new expansion condition is formed by the stack of expansion symbols (labelled “Wild”), in which a symbol in expansion array area 512, highlighted with markings, is shown to be in the position adjacent to boundary 513. As can be understood the sequence of block 418 returning to repeat blocks 414 and 416, a “cascade” of expansion conditions may occur in which two or more expansion conditions are formed by expansion symbols being present in locations that result in the process at block 418 returning to block 414. In this embodiment, for each additional expansion condition, the process also applies a new multiplier higher than the first multiplier to all winning game symbol groups formed using the new stack of expansion symbols that created the expansion condition. Such a multiplier is shown in FIG. 10, where the stack of expansion symbols resulting in the second expansion condition receives a 3× multiplier.

Once all of the new expansion conditions have been recognized and handled by the process at block 418, the process goes to block 420 where it determines if any reels or column are remaining in the symbol array to be stopped or newly populated. If so, the process goes to block 422 where it stops the next reel or populates the next column of symbols. If not, the process goes to block 424. At block 422, the newly populated symbols are displayed as discussed above, with all symbols populated to the active array area displayed, while only designated symbols are displayed in the expansion array area. For example, as shown in FIG. 10, two reels 508 and 509 are still spinning following the second expansion condition being implemented by the process. This movement is shown by the blurry symbols indicating movement of the reels. As can be understood, in this embodiment, during the play at the gaming machine, at least one of the reels remains spinning while other reels are stopped and evaluated for an expansion condition. In other embodiments, all of the reels may be processed for expansion conditions together after they have stopped. Similarly, if reels are not employed, either option for sequential processing or processing together may be used for implementing expansion conditions in various embodiments.

After all remaining reels are columns have been populated or stopped, and any expansion conditions handled, the process at block 420 goes to block 424, where the process controls the gaming machine to award any prize defined for a winning game symbol group contained in the enlarged active array area. Block 424 may include conducting bonus features related to bonus symbols appearing in the symbol array. For example, bonus symbols may trigger awards of jackpots such as the Major or Minor jackpots displayed in FIG. 5, or may trigger bonus games or bonus features in which jackpot awards are available to be won.

FIGS. 5 through 11 may now be used to describe specific implementations of a process such as that as outlined in FIG. 4. Referring first to FIG. 5, the example reel-type game includes graphics displayed in an area 501 which may be provided by a video display device such as display device 104 shown in FIG. 1. The displayed graphics include an initial array of game symbol location made up of an active array area 502 including, in the depicted state, twenty locations 504, and an expansion array area 512 including, in the depicted state, thirty locations 504. Active array area 502 and expansion array area 512 are separated by a boundary 513, which may be visually indicated with a graphical boundary of some type, or may be indicated by change in coloration and animation of the symbols in each respective area 502 and 512. For example, expansion array area 512 may be visually indicated with a display of a graphic element such as a curtain generally positioned as indicated by the dotted box labelled 512, under which only certain symbols are visible in graphic format indicating they are inactive. To enlarge the active array area using such a graphical presentation, the curtain is depicted being raised to uncover the rows that are added to the active array area.

In this example, each column of ten locations 504 is defined by a multiple-symbol reel representation including a first reel 505, a second reel 506, a third reel 507, a fourth reel 508, and a fifth reel 509. In the state of the display shown in FIG. 5, a play in a base portion of the game is in progress. For the purpose of this example, the game symbols other than the expansion symbols and bonus symbols are indicated with a letter and number, such as “F6”, “F7”, “M1”, and “M2”. As can be seen in expansion array area 512, only expansion symbols, labelled “Wild”, and bonus symbols are visible in expansion array area 512.

The illustrated game graphics also include an area 514 for showing credits available for play, an area 515 showing an amount of a win for the most recent play of the game, a multiplier display area 516, a bet level display area 517, and a denomination display area 518. Of these display areas, area 514 and area 515 are shown blank for purposes of this description. It will be appreciated, however, that these areas would show credit values in an actual implementation. As indicated by the arrows in overlaying fourth reel 508 and fifth reel 509, in the depicted state these reels are still spinning to present a game.

The example of FIG. 5 also shows a number of jackpot prize values toward the top of display area 501. These prize values are displayed as variables for the purposes of this description, and include “Major” and “Minor” prizes. The value of these prizes in an actual implementation of the game may be fixed values or values which vary in some fashion over time. One or more of the jackpot prizes might be defined as a local or wide area progressive prize which increases substantially continuously based on the value of wagers placed in the gaming system. The prizes may be shown as currency values as indicated in the figures, or as credit values.

FIGS. 6-11 show a sequence of game screen diagrams illustrating different points in time in a game conducted according to the process of FIG. 4 according to some embodiments. The diagrams are arranged largely like that of FIG. 5, and depict a sequence of gaming events in which multiple expansions of the active array area 502 occur in a feature referred to in one preferred game theme as a “Potion Explosion”. In this implementation, a number of paylines are defined through active array area, as shown at payline indicator 602. As the active array area increases, the number of paylines are also increased.

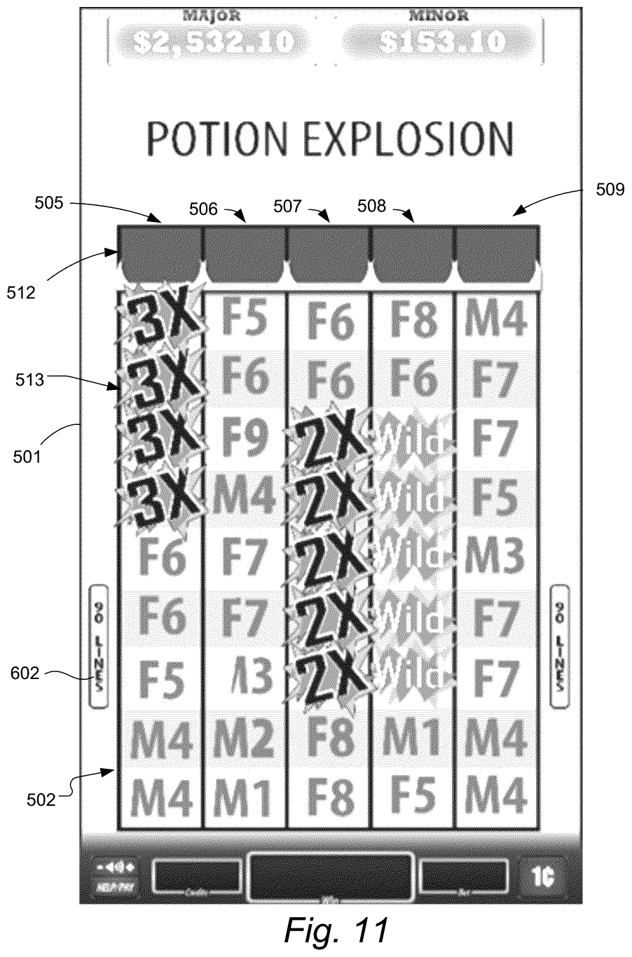

In FIG. 6, three reels have been stopped and an expansion condition is detected on reel 507. FIG. 7 shows the expanded active array area 502 after the expansion has occurred. FIG. 8 shows a multiplier being applied to the stack of expansion symbols which triggered the expansion of FIG. 7. FIG. 9 shows the result of a second expansion caused by the stack of expansion symbols in reel 505. FIG. 10 shows a multiplier being applied to the stack of expansion symbols which triggered the expansion of FIG. 9. FIG. 11 shows the final state of the active array area after reels 508 and 509 have been stopped following the state shown in FIG. 10.

The outcome of any game conducted in accordance with the present invention, that is, the prize to be awarded, may be determined in any suitable fashion. In some implementations the various reels may be designed so that they may be randomly stopped and will produce a desired payout and hold over time. Other implementations may obtain a random outcome or an outcome from another game such as “bingo” and then control the various reel spins according to the invention to produce correspond to that outcome.

One way to obtain a random outcome (in terms of prize value) to be displayed through the play described herein uses a random number generator to generate a random number which is used to index a table to lookup an outcome. In such an arrangement, the outcomes are stored in a lookup table which is indexed by the random number to provide suitable distributed, randomly-selected results. The lookup table may have a number of outcome entries, each with an index, a prize amount in credits, and a bonus flag. The outcome entry may have other data fields to control other parts of the game. The bonus flag indicates that the outcome is to be displayed with both the base and bonus portion of game play described above.

As one alternative to a game outcome determined by random number, outcomes be selected from an outcome record pool of predetermined outcome records. In those arrangements, an outcome record may be chosen from a record pool in order to service a play initiated at the gaming machine. Such an outcome record may be chosen from the pool either randomly or from a randomly-organized queue. The chosen record may include a record identifier (rather than an index), a prize amount, and a free-spin bonus flag. An outcome record may have other data fields to control other parts of the game. The free-spin bonus flag indicates that the record outcome will trigger the bonus portion of play. Still other implementations may use a server-hosted bingo game with multiple game play requests participating as bingo cards, the bingo patterns determining prize outcomes.

In some implementations of the invention, one or both of the base portion of play or the bonus portion of play may be controlled by a script which controls the various reel spins to land on game symbols to produce the randomly selected or otherwise obtained outcome for the play. In order to provide a natural feel to the play of the game, numerous scripts may be stored for each potential outcome and the particular script to be used to control the game for a given play may be selected randomly from the scripts available to show the given outcome.

Numerous variations are possible on the example processes described in connection with FIG. 4 and in connection with FIGS. 5-11. For example, the play arrangement shown in FIG. 4 may be used with other bonus play trigger arrangements and is not limited to the process shown in FIG. 4. Another variation may be that the bonus play process described in FIG. 4A and FIGS. 9-11 may not require rearranging the initial array of game symbol locations to produce a bonus array of game symbol locations.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as top, bottom, upper, lower, and the like with reference to a given feature are intended only to identify a given feature and distinguish that feature from other features. Unless specifically stated otherwise, such terms are not intended to convey any spatial or temporal relationship for the feature relative to any other feature.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above described preferred embodiments are intended to illustrate the principles of the invention, but not to limit the scope of the invention. Various other embodiments and modifications to these preferred embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A method of controlling a reel-type gaming machine, the method including:
controlling a display system of the gaming machine to display a game symbol array for a play at the gaming machine including an active array area in which symbols are shown and evaluated, and an expansion array area in which symbols are not shown or are shown in an inactive state;
during the play at the gaming machine, populating at least some game symbol locations in the active array area and at least some game symbols in the expansion array area with a respective game symbol selected from a first game symbol set which includes a first expansion symbol;
responsive to an expansion condition in which a selected expansion symbol appears in the expansion area adjacent to a boundary between the active array area and the expansion array area, controlling the display system of the gaming machine to enlarge the active array area by moving the boundary only sufficiently to include the selected expansion symbol;
responsive to moving the boundary, showing and evaluating symbols in a new active array area created by moving the boundary; and
after moving the boundary, controlling the gaming machine to award any prize defined for a winning game symbol group contained in the enlarged active array area.

2. The method of claim 1 wherein the expansion condition includes a selected stack of expansion symbols which includes the symbol in the expansion array area adjacent to a boundary between the active array area and the expansion array area, and the response includes controlling the display system of the gaming machine to enlarge the active array area by moving the boundary only sufficiently to include the selected of stack of expansion symbols.

3. The method of claim 2 further comprising, after moving the boundary, responsive to a second expansion condition caused by a second stack of expansion symbols, controlling the display system of the gaming machine to move the boundary only sufficiently to include the second stack of expansion symbols to enlarge the active array area a second time.

4. The method of claim 3 further comprising applying a first multiplier to all winning game symbol groups formed using the selected stack of expansion symbols, and applying a second multiplier higher than the first multiplier to all winning game symbol groups formed using the second stack of expansion symbols.

5. The method of claim 1 wherein only symbols of a designated group of symbol types are shown in the inactive state in the expansion array area, with other symbol types not being shown, the designated group of symbol types including at least expansion symbols.

6. The method of claim 1 wherein the expansion symbols, responsive to appearing in the active array area, are evaluated as wild symbols, and responsive to appearing in the expansion array area, are evaluated only for causing an expansion event, and then evaluated as wild symbols responsive to appearing in the enlarged active array area.

7. The method of claim 1 further comprising increasing a number of paylines used to form winning game symbol groups when enlarging the active array area.

8. The method of claim 1 wherein:
the active array area and the expansion array area comprise reels presented as columns of the game symbol array; and
during the play at the gaming machine, at least one of the reels remains spinning while other reels are stopped and evaluated for an expansion condition.

9. A gaming machine, the gaming machine including:
(a) a display system;
(b) a player input system;
(c) at least one processor; and
(d) at least one memory device storing instructions executable by the at least one processor to:
cause the display system to display a game symbol array for a play at the gaming machine including an active array area in which symbols are shown and evaluated, and an expansion array area in which symbols are not shown or are shown in an inactive state;
during the play at the gaming machine, populate at least some game symbol locations in the active array area and at least some game symbols in the expansion array area with a respective game symbol selected from a first game symbol set which includes a first expansion symbol;
responsive to an expansion condition in which a selected expansion symbol appears in the expansion area adjacent to a boundary between the active array area and the expansion array area, control the display system of the gaming machine to enlarge the active array area by moving the boundary only sufficiently to include the selected expansion symbol;
responsive to moving the boundary, cause the display system to show and evaluate symbols in a new active array area created by moving the boundary; and
after moving the boundary, award any prize defined for a winning game symbol group contained in the enlarged active array area.

10. The gaming machine of claim 9 wherein the expansion condition includes a selected stack of expansion symbols which includes the symbol in the expansion array area adjacent to a boundary between the active array area and the expansion array area, and the response includes controlling the display system of the gaming machine to enlarge the active array area by moving the boundary only sufficiently to include the selected of stack of expansion symbols.

11. The gaming machine of claim 10 wherein the instructions are further executable by the at least one processor for, responsive to a second expansion condition caused by a second stack of expansion symbols, controlling the display system of the gaming machine to move the boundary only sufficiently to include the second stack of expansion symbols to enlarge the active array area a second time.

12. The gaming machine of claim 11 wherein the instructions are further executable by the at least one processor for applying a first multiplier to all winning game symbol groups formed using the selected stack of expansion symbols, and applying a second multiplier higher than the first multiplier to all winning game symbol groups formed using the second stack of expansion symbols.

13. The gaming machine of claim 9 wherein only symbols of a designated group of symbol types are shown in the inactive state in the expansion array area, with other symbol types not being shown, the designated group of symbol types including at least expansion symbols.

14. The gaming machine of claim 9 wherein the expansion symbols, responsive to appearing in the active array area, are evaluated as wild symbols, and responsive to appearing in the expansion array area, are evaluated only for causing an expansion event, and then evaluated as wild symbols responsive to appearing in the enlarged active array area.

15. The gaming machine of claim 9 wherein the instructions are further executable by the at least one processor for increasing a number of paylines used to form winning game symbol groups when enlarging the active array area.

16. The gaming machine of claim 9 wherein:
the active array area and the expansion array area comprise reels presented as columns of the game symbol array; and
during the play at the gaming machine, at least one of the reels remains spinning while other reels are stopped and evaluated for an expansion condition.

17. A program product comprising one or more tangible, non-transitory computer readable data storage devices storing program code for a reel-type gaming machine, the program code including:
first program code executable by at least one processor to cause a display system of the gaming machine to cause the display system to display a game symbol array for a play at the gaming machine including an active array area in which symbols are shown and evaluated, and an expansion array area in which symbols are not shown or are shown in an inactive state; and during the play at the gaming machine, populate at least some game symbol locations in the active array area and at least some game symbols in the expansion array area with a respective game symbol selected from a first game symbol set which includes a first expansion symbol;
array expansion program code executable by at least one processor to cause the display system of the gaming machine to cause the display system to, responsive to an expansion condition in which a selected expansion symbol appears in the expansion area adjacent to a boundary between the active array area and the expansion array area, controlling the display system of the gaming machine to enlarge the active array area by moving the boundary only sufficiently to include the selected expansion symbol;
second program code executable by at least one processor to cause a display system of the gaming machine to cause the display system to, responsive to moving the boundary, cause the display system to show and evaluate symbols in a new active array area created by moving the boundary; and
prize assignment program code executable by at least one processor to cause a display system of the gaming machine to cause the gaming machine to, after the boundary is moved, award any prize defined for a winning game symbol group contained in the enlarged active array area.

18. The program product of claim 17 wherein the expansion condition includes a selected stack of expansion symbols which includes the symbol in the expansion array area adjacent to a boundary between the active array area and the expansion array area, and the response includes controlling the display system of the gaming machine to enlarge the active array area by moving the boundary only sufficiently to include the selected of stack of expansion symbols.

19. The program product of claim 17 wherein the array expansion program code is further executable for, responsive to a second expansion condition caused by a second stack of expansion symbols, controlling the display system of the gaming machine to move the boundary only sufficiently to include the second stack of expansion symbols to enlarge the active array area a second time.
